(19) United States
(12) Patent Application Publication
(10) Pub. No.: US 2002/0108700 A1
(43) Pub. Date: Aug. 15, 2002

(54) Method of wrapping a floral grouping

(76) Inventors: Donald E. Weder, Highland, IL (US); David A. Weder, Highland, IL (US)

Correspondence Address: DUNLAP, CODDING & ROGERS P.C., PO BOX 16370, OKLAHOMA CITY, OK, 73114, US

(21) Appl. No.: 10/013,876

(22) Filed: Dec. 11, 2001

Related U.S. Application Data
(63) Continuation-in-part of application No. 09/532,940, filed on Mar. 22, 2000, now abandoned.
Application No. 09/532,940 is a continuation of application No. 08/767,168, filed on Dec. 16, 1996, now abandoned.
Application No. 08/767,168 is a continuation of application No. 08/469,033, filed on Jun. 6, 1995, now Pat. No. 5,615,774.
Application No. 08/469,033 is a continuation of application No. 08/347,611, filed on Nov. 30, 1994, now Pat. No. 5,526,932.
Application No. 08/347,611 is a continuation-in-part of application No. 08/165,215, filed on Dec. 10, 1993, now Pat. No. 5,373,943.
Application No. 08/165,215 is a continuation of application No. 08/040,330, filed on Mar. 30, 1993, now Pat. No. 5,311,991.
Application No. 08/040,330 is a division of application No. 07/906,089, filed on Jun. 29, 1992, now Pat. No. 5,205,108.

(51) Int. Cl. B31C 1/00; B65H 81/00

(52) U.S. Cl. 156/191; 156/198; 156/210; 156/213

(57) ABSTRACT

A method of covering a floral grouping by providing a wrap constructed of a flat sheet of material, the wrap having an opening disposed within the sheet of material, and inserting a portion of the stem end of a floral grouping through the opening in the wrap, and wrapping the wrap about the floral grouping.

### BACKGROUND

This present invention relates to a wrap for a floral grouping and a method for wrapping a floral grouping with such wrap and, more particularly, but not by way of limitation, to a wrap having an opening therein and wherein a stem end of the floral grouping is extended through the opening and the wrap then is wrapped about the floral grouping.

### BRIEF DESCRIPTION OF THE DRAWINGS

FIG. 1 is a plan view of the upper surface of a wrap constructed in accordance with the present invention.

FIG. 2 is a cross-sectional view of the wrap of FIG. 1, taken substantially along the line 2-2 of the FIG. 1.

FIG. 3 is a cross-sectional view of the wrap of FIGS. 1 and 2 showing a floral grouping having the stem end thereof initially inserted through a opening in the wrap.

FIG. 4 is a perspective view of the wrap of FIGS. 1, 2 and 3 showing the wrap formed and wrapped about the floral grouping.

FIG. 5 is a cross-sectional view of a wrap similar to that shown in FIG. 3, except the modified wrap shown in FIG. 5 has adhesive on the opposite surface of the wrap as compared to the surface of the wrap having the adhesive thereon shown in FIGS. 1 through 4.

FIG. 6 is a cross-sectional view of another modified wrap, similar to FIGS. 2 and 5, except the wrap shown in FIG. 6 has adhesive on only a portion of the upper surface thereof.

FIG. 7 is a cross-sectional view of still another modified wrap, similar to FIG. 6, but the modified wrap shown in FIG. 7 has adhesive on only a portion of the lower surface thereof.

FIG. 8 is a cross-sectional view of a portion of a wrap constructed exactly like the wrap shown in FIG. 6, except the modified wrap show in FIG. 8 comprises two sheets of material having a draw string laminated therebetween.

FIG. 9 is an elevational view of the wrap of FIG. 8 shown wrapped or formed about a floral grouping.

FIG. 10 is an elevational view showing a wrap wrapped about a floral grouping and secured thereabout by banding element.

FIG. 11 is a cross-sectional view of the wrap and floral grouping of FIG. 10 (without a banding element) disposed within a vase.

### DESCRIPTION OF THE PREFERRED EMBODIMENTS

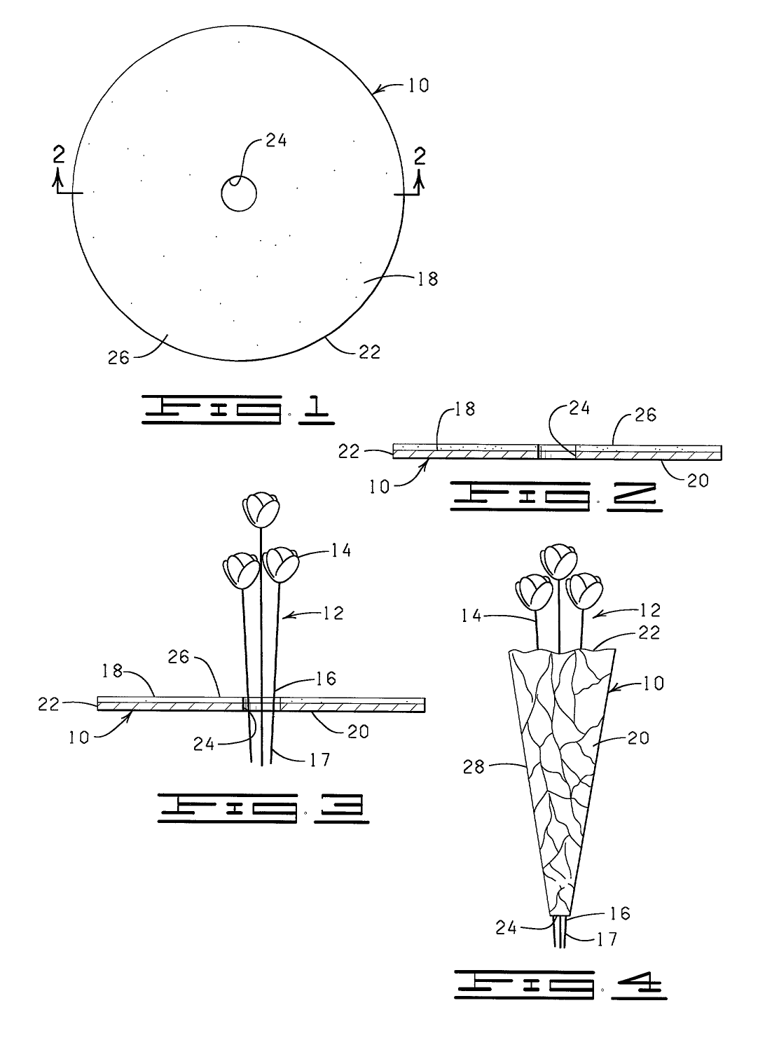

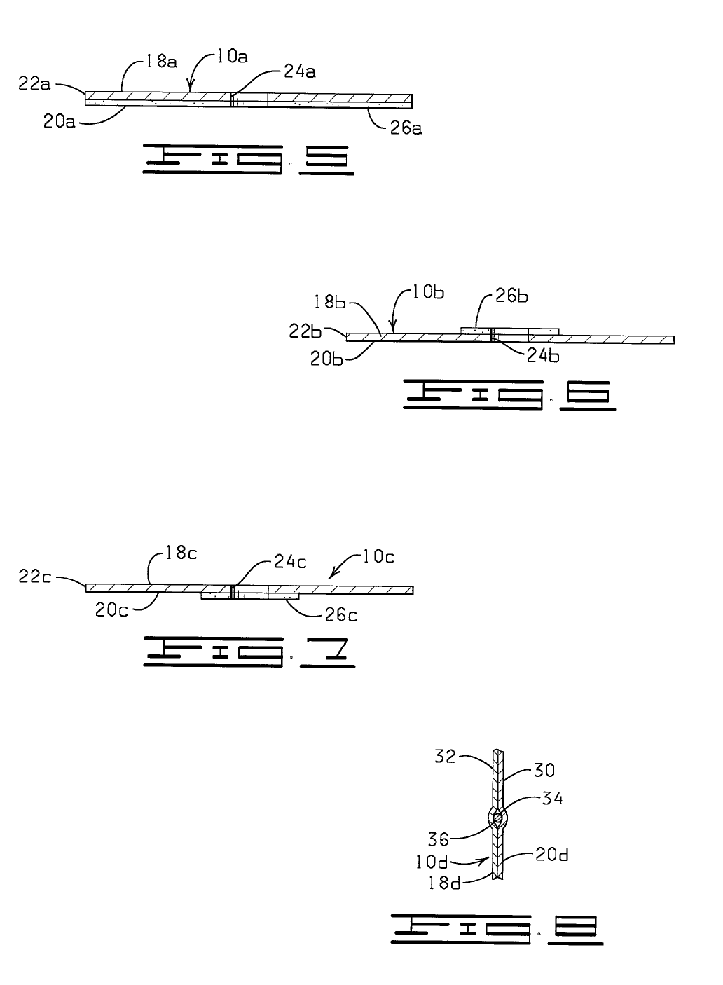

The present invention relates to a packaging comprising a wrap 10 (FIGS. 1, 2, 3, and 4) for wrapping a floral grouping 12 (FIGS. 3 and 4) having a bloom end 14 and a stem end 16. The wrap 10 has an upper surface 18 (FIGS. 1, 2 an 3) and a lower surface 20 (FIGS. 2, 3 and 4). The wrap 10 also has an outer periphery 22 (FIGS. 1-4).

As shown in FIGS. 1-4, the wrap 10 is generally circularly shaped. However, the wrap 10 may be rectangularly shaped or square shaped or any other geometric shape.

The wrap 10 is constructed of a sheet of material or a plurality of sheets of material where the sheets of material are laminated to each other or laid or disposed simply one on top of the other. The wrap 10 may be constructed from a variety of materials. The wrap 10 is constructed from any substantially flat, flexible suitable sheet of material that is capable of being wrapped about the floral grouping 12. Preferably, the wrap 10 is constructed of treated or untreated paper foil, synthetic or natural polymeric film, natural or synthetic fabric, burlap, cling material, denim or combinations thereof.

The term synthetic “polymeric film” means a synthetic resin such as a polypropylene as opposed to naturally an occurring resin such as cellophane.

Synthetic polymeric films are relatively strong and not a subject to tearing (substantially non-tearable), as might be the case with paper or foil. Further, a relatively substantially linearly linked processed synthetic polymeric film is virtually waterproof which may be desirable in many applications such as wrapping a floral grouping.

The sheet of material may be a shape-sustaining material such as foil, cling wrap, or a metalized polymeric film or paper. A shape-sustaining material is one which substantially holds its shape, after being formed into a particular shape, without additional securing devices or elements.

A decorative pattern, such as a color and/or an embossed pattern, and/or other decorative surface ornamentation may be applied to the upper surface 18 and/or the lower surface 20 of the wrap 10 or portions thereof including, but not limited to printed design, coatings, colors, flocking or matellic finishes. The wrap 10 also may be totally or partially clear or tinted transparent material.

The wrap 10 may be constructed of a single layer of material or a plurality of layers of the same or different types of materials. Any thickness of the wrap 10 may be utilized in accordance with the present invention as long as the wrap 10 is wrappable about the floral grouping 12 as described herein. Additionally, an insulating material such as bubble film, preferable as one of two layers, can be utilized in order to provide needed protection for the floral grouping 12. In preferred embodiment, the wrap 10 is constructed from two polypropylene films (a 20″×15″ sheet of Mobil 270 ABW white opague film laminated to a 20″×15″ sheet of Mobil 220 AB clear film) having a thickness in a range of from less than about 1.0 mil to about 30.0 mils, and more preferably to about 10.0 mils.

“Floral grouping” as used herein means cut fresh flower, artificial flowers, other fresh and/or artificial plants or other floral materials and may include other secondary plants and/or ornamentation which add to the aesthetics of the overall floral grouping 12. The term “floral grouping” as used herein also is intended to include a single flower or plant.

“Cling Wrap or Material” as used herein means any material which is capable of connecting to the sheet of material and/or itself upon contacting engagement during the wrapping process and is wrappable about the floral grouping 12 whereby portions of the cling material contactingly engage and connect to other portions of the wrapping material for generally securing the wrap 16 wrapped about at least a portion of the floral goruping 12. This connecting engagement is preferably temporary in that the wrap 10 may be easily removed without tearing same, i.e., the cling material “clings” to the wrap 10. A wrapping material which remains securely connected to and about the wrapped item until the wrapping material is torn therefrom.

The cling material is constructed and treated if necessary, from polyethylene such as Cling Wrap made by GladN, First Brands Corporation, Danbury, Conn. The thickness of the cling material will, in part, depend upon the thickness of the sheet of material utilized, i.e., generally, the thicker and therefore heavier sheet of material may require a thicker and therefore stronger cling material. The cling material will range in thickness from less than about 0.2 mil to about 10 mils, and preferably less than about 0.5 mil to about 2.5 ils and most preferably from less than about 0.6 mil to about 2 mils. However, any thickness of cling material may be utilized in accordance with the present invention which permits the cling material to function as described herein.

An opening 24 (FIGS. 1-4) is formed through a portion of the wrap 10. Preferably, the opening 24 is formed through a central portion of the wrap 10. The opening 24 intersects the upper and lower surfaces 18 and 20 of the wrap 10 and is spaced a distance from the outer periphery 22. The opening 24 may be a slot rather than a circular hole.

A bonding material 26 which may be an adhesive or cohesive material may be applied to the a portion of the upper surface 18 of the wrap 10. As shown in FIGS. 1, 2 and 3, the bonding material 26 may be applied substantially to the entire upper surface 18 of the wrap 10. The bonding material 26 can be applied to the wrap 10 in strips or spots and may cover only a portion of the upper and/or lower surfaces 18 and 20. The thickness of the bonding material 26 is exaggerated in FIGS. 1-3 for illustration purposes.

In operation, the stem end 16 (having a plurality of stems 17) of the floral grouping 12 is inserted through the opening 24 to a position wherein a portion of the plurality of stems 17 of the stem end 16 extends through the opening 24 and a distance beyond the lower surface 20 of the wrap 18. The wrap 10 then is formed about the floral grouping 12 with the upper surface 18 of the wrap 10 being disposed near the floral grouping 12 and the wrap 10 encompassing a substantial portion of the floral grouping 12 while a portion of the plurality of stems 17 of the stem end 16 of the floral grouping 12 remains extended through the opening 24, as shown in FIG. 4. In one preferred form, the wrap 10 will substantially encompass the bloom end 14 of the floral grouping 12, although the bloom end 14 is shown in FIG. 4 extended above the wrap 10 for illustration purposes. It should be noted, that, in some application, the bloom end 14 of the floral grouping 12 may extend upwardly beyond the wrap 10, as shown in FIG. 4.

Preferably, the wrap 10 is tightly folded or wrapped about a portion of the stem end 16 of the floral grouping 12 and portions of the wrap 10 with the bonding material 26 thereon are brought into contact and bonded with other portions of the wrap 10 having the bonding material 26 thereon for cooperating to secure the wrap 10 tightly wrapped about the stem end 16 of the floral grouping 12. Further, as the wrap 10 is formed about the bloom end 14 of the floral grouping 12, portions of the wrap 10 having the bonding material 26 thereon are brought into contact and bonded with adjacent portions of the wrap 10 with the bonding material thereon to form bonded overlapping folds 28 to secure the wrap 10 loosely wrapped about the bloom end 14 of the floral grouping 12. Portions of the bonding material 26 may also are brought into contact to and bonded with portions of the stem end 16 of the floral grouping 12 thereby bonding the wrap 10 to the floral grouping 12 generally about a portion of the stem end 16 for securing the wrap 10 to the floral grouping 12 and for substantially preventing the floral grouping 12 from sliding or moving within or out of the wrap 10. The overlapping folds 28 are formed by portions of the wrap 10 overlapping each other and adjacent portions of the wrap 10 with the bonding material 26 thereon may be bonded together forming bonded overlapping and adjacent portions.

### EMBODIMENT OF FIG. 5

Shown in FIG. 5 is a modified wrap 10a which is constructed generally like the wrap 10 shown in FIGS. 1-4 and described in detail before, having an upper surface 18a, an outer periphery 22a, and an opening 24a, except a bonding material 26a may be disposed on a lower surface 20a of the wrap 10a. The wrap 10a is wrapped about the floral grouping in a manner exactly like that described before with respect to the wrap 10, except the bonding material 26a will not bond to the stem end 16 of the floral grouping 12. Rather, overlapping folds like the overlapping folds 28 are formed in the wrap 10a generally about the stem end 16 and the overlapping folds cooperate to secure the wrap 10a tightly wrapped about the stem end 16.

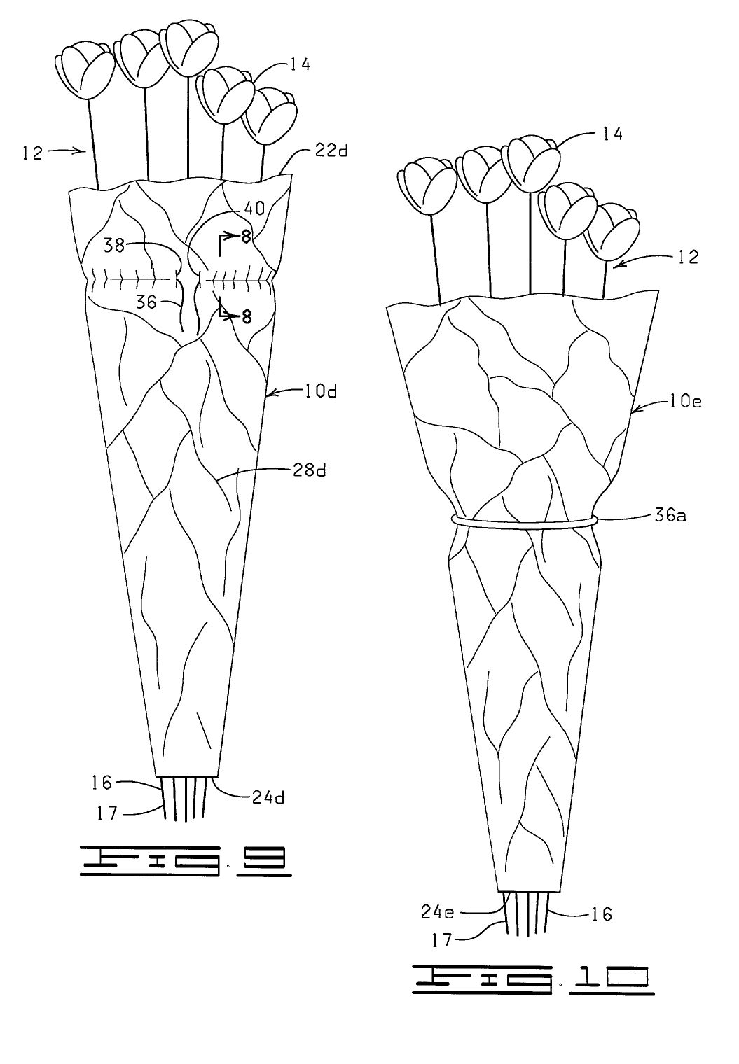

### EMBODIMENT OF FIG. 6

Shown in FIG. 6 is a wrap 10b which is constructed generally like the wrap 10 shown in FIGS. 1-4, having an upper surface 18b and a lower surface 20b, except a bonding material 26b on the upper surface 18b of the modified wrap 10b is disposed adjacent an opening 24b with the bonding material 26b extending a distance from the opening 24b. The wrap 10b is wrapped about the floral grouping in a manner exactly like that described before with respect to the wrap 10 with the bonding material 26b cooperating to tightly secure the wrap 10b about the stem end 16 of the floral grouping 12, except the overlapping folds formed in the wrap 10b extending generally about the bloom end 14 of the floral grouping 12 are not bonded since the bonding material 26b does not extend to an outer periphery 22b. The bonding material 26b extends only from the opening 24b a distance outwardly toward the outer periphery 22b and is spaced an intermediate distance from the outer periphery 22b.

### EMBODIMENT OF FIG. 7

Shown in FIG. 7 is a wrap 10c constructed generally like the wrap 10b shown in FIG. 6 having an upper surface 18c, an outer periphery 22c, and an opening 24c, except a bonding material 26c is disposed on a lower surface 20c of the wrap 10c.

### EMBODIMENT OF FIGS. 8-11

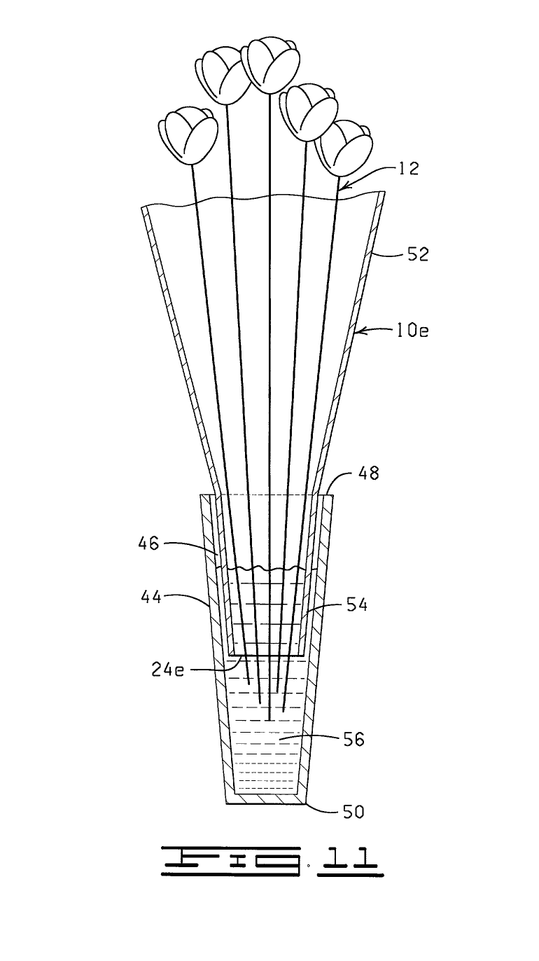

Shown in FIGS. 8 and 9 is another modified wrap 10d, the wrap 10d being only partially shown in FIG. 8. The wrap 10d is constructed generally like the wrap 10b (FIG. 6 or the wrap 10c (FIG. 7) having an upper surface 18d, and a lower surface 20d and an opening 24d, except the wrap 10d specifically comprises two sheets of material 30 and 32 (FIG. 8) laminated together with a space 34 being formed between the two sheets of material 30 and 32 near and spaced a distance from an outer periphery 22d of the wrap 10d and with a banding element 36 extending through the space 34 between the two sheets of material 30 and 32 and with the opposite ends of the banding element 36 extending outwardly through openings 38 and 40 in the wrap 10d, as shown in FIG. 9.

In this embodiment, the wrap 10d may be tightly wrapped about the stem end 16 and secured thereto via a bonding material (not shown) in a manner generally like that described before to form bonded overlapping folds 28d. The wrap 10d may loosely secured about the bloom end 14 of the floral grouping 12 by pulling the banding element 36 and then securing the banding element 36 after the wrap 10d has been loosely gathered and secured abut the bloom end 14 of the floral grouping 12.

In FIGS. 8 and 9 the banding element 36 is shown as a drawstring attached to the wrap 10d. However, as shown in FIG. 10 a banding element 36a may alternatively be a broad or narrow band, a ribbon, a drawstring, a string, a wire, an elastic band, or any other similar device which is disposed about the wrap 10 formed about a portion of the floral grouping 12. The stem end 16 of the floral grouping 12 extends through an opening 24e in a wrap 10e. The banding element 36a may be attached to the wrap 10e or may be separate from the wrap 10e and secured thereto only after the wrap 10e has been formed about the floral grouping 12. The banding element 36a may alternatively be a piece of heat shrink material, well known to those of ordinary skill in the art, to which heat may be applied to cause the banding element 36a to be shrunk about the wrap 10e thus causing the wrap 10e to be secured about the floral grouping 12. The banding element 36a may be any device capable of being placed about the wrap 10e to hold the wrap 10e about the floral grouping 12. Further, more than one banding element 36a may be disposed about the wrap 10e.

Shown in FIG. 11 is the wrap 10e which has been wrapped about the floral grouping 12 as shown in FIG. 10 except that instead of disposing the banding element 36a about the wrap 10e to hold the wrap 10e about the floral grouping 12, the floral grouping 12 and a lower portion 54 of the wrap 10e disposed thereabout are disposed into an interior space 46 of a vase 44. The vase 44 has an upper end 48 and a lower end 50.

An upper portion 52 of the wrap 10e extends above the upper end 48 of the vase 44 and serves as a decorative wrap about the floral grouping 12. The stem end 16 of the floral grouping 12 preferably but not necessarily extends below the opening 24e of the wrap 10e into the interior space 46 of the vase 44. Water 56 or other growing medium may also be disposed within the interior space 46.

changes may be made in the construction in the operation of the various components, elements and assemblies of the wrap described herein and changes may be made in the steps or the sequence of steps of the methods described herein without departing from the spirit and the scope of the invention as defined in the following claims.

What is claimed is:

1. A method of wrapping a floral grouping, comprising:
providing a floral grouping having a bloom end and having a stem end having a plurality of stems;
providing a wrap comprising a flat sheet of material, the wrap having an upper surface, a lower surface, an outer periphery and an opening in the wrap spaced a distance inwardly from the outer periphery;
inserting the stem end of the floral grouping into the opening in the wrap wherein the plurality of stems in the stem end of the floral grouping extend a distance from the lower surface of the wrap; and
forming the wrap about the floral grouping to encompass at least a portion of the bloom end of the floral grouping wherein a plurality of overlapping folds are formed in the wrap to secure the wrap about the floral grouping and wherein the plurality of stems of the stem end of the floral grouping remain extended a distance from the opening of the wrap.

2. The method of claim 1 wherein the wrap is tightly formed about the stem end of the floral grouping.

3. The method of claim 1 wherein the wrap is loosely formed about the bloom end of the floral grouping.

4. The method of claim 1 wherein the opening is positioned in a substantially central portion of the wrap.

5. The method of claim 1 wherein the sheet of material used to construct the wrap is constructed of material selected from the group consisting of treated or untreated paper, foil, synthetic or natural polymeric films, natural or synthetic fabric, burlap, denim, cling material, a shape-sustaining material, or combinations thereof.

6. The method of claim 1 comprising the additional step of securing the wrap about the floral grouping by disposing a banding element about a portion of the wrap.

7. The method of claim 1 comprising the additional step of disposing a portion of the wrap and floral grouping within a vase, wherein an upper portion of the wrap extends above an upper end of the vase, the vase serving to retain the wrap in a position about the floral grouping.

8. A method of wrapping a floral grouping, comprising:
providing a floral grouping having bloom end and having a stem end having a plurality of stems;
providing a wrap comprising a flat sheet of material, the wrap having an upper surface, a lower surface, an outer periphery and an opening in the wrap spaced a distance inwardly from the outer periphery;
inserting the stem end of the floral grouping into the opening in the wrap wherein the plurality of stems in the stem end of the floral grouping extend a distance from the lower surface of the wrap;
forming the wrap about the floral grouping to encompass at least a portion of the bloom end of the floral grouping wherein a plurality of overlapping folds are formed in the wrap, and wherein the plurality of stems of the stem end of the floral grouping remain extended a distance from the opening of the wrap; and
securing the wrap about the floral grouping by disposing a banding element about a portion of the wrap.

9. The method of claim 8 wherein the wrap is tightly formed about the stem end of the floral grouping.

10. The method of claim 8 wherein the wrap is loosely formed about the bloom end of the floral grouping.

11. The method of claim 8 wherein the opening is positioned in a substantially central portion of the wrap.

12. The method of claim 8 wherein the sheet of material used to construct the wrap is constructed of material selected from the group consisting of treated or untreated paper, foil, synthetic or natural polymeric films, natural or synthetic fabric, burlap, denim, cling material, a shape-sustaining material, or combinations thereof.

13. A method for wrapping a floral grouping comprising:
providing the floral grouping having a bloom end and a stem end having a plurality of stems;
providing a substantially flat, flexible wrap having an upper surface and a lower surface and an outer periphery, an opening being formed through a portion of the wrap intersecting the upper and the lower surfaces of the wrap and being spaced inwardly a distance from the outer periphery;
inserting the stem end of the floral grouping into the opening to a position wherein the stem end of the floral grouping extends a distance beyond the lower surface of the wrap;
forming the wrap about the floral grouping with the upper surface of the wrap being disposed near the floral grouping and the wrap encompassing a substantial portion of the floral grouping while a portion of the stem end of the floral grouping remains extended a distance through the opening; and
securing a drawstring about the wrap to gather the wrap about the floral grouping.

14. The method of claim 13 wherein the wrap is tightly formed about the stem end of the floral grouping.

15. The method of claim 13 wherein the wrap is loosely formed about the bloom end of the floral grouping.

16. The method of claim 13 wherein the opening is positioned in a substantially central portion of the wrap.

17. The method of claim 13 wherein the sheet of material used to construct the wrap is constructed of material selected from the group consisting of treated or untreated paper, foil, synthetic or natural polymeric films, natural or synthetic fabric, burlap, denim, cling material, a shape-sustaining material, or combinations thereof.
